(19) United States
(12) Patent Application Publication
(10) Pub. No.: US 2006/0187746 A1
(43) Pub. Date: Aug. 24, 2006

(54) Agitator base for plastic container

(75) Inventor: Richard K. Ogg, Littlestown, PA (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 11/339,843

(22) Filed: Jan. 26, 2006

Related U.S. Application Data
(60) Provisional application No. 60/646,997, filed on Jan. 27, 2005.

(51) Int. Cl. B01F 13/00

(52) U.S. Cl. 366/130

(57) ABSTRACT

A plastic container is provided for containing a fluid. The container has a base; a sidewall attached to the base and extending upward from the base; a top receiving portion for receiving a top for sealing the container; and at least one protrusion protruding upward from the base, the protrusion forming a mixing surface that is for promoting movement of the fluid when the container is shaken.

This application claims the benefit of U.S. Provisional Patent Application No. 60/646,997 filed Jan. 27, 2005, which is hereby incorporated by reference in its entirety.

### BACKGROUND OF THE INVENTION

The invention relates to a base for a plastic container. The base having a shape that promotes the agitation of a material in the container.

### SUMMARY OF THE INVENTION

An embodiment of the invention provides a plastic container for containing a fluid. The container has a base; a sidewall attached to the base and extending upward from the base; a top receiving portion for receiving a top for sealing the container; and at least one protrusion protruding upward from the base, the protrusion forming a mixing surface that is for promoting movement of the fluid when the container is shaken.

### BRIEF DESCRIPTION OF THE DRAWINGS

Further advantages and details of the invention follow from the exemplary embodiments and are explained in the following with the aid of the Figures, in which:

FIG. 1 is a perspective view of the bottom of a container in accordance with the invention; and

FIG. 2 is a top perspective view of the container shown in FIG. 1.

### DETAILED DESCRIPTION OF THE INVENTION

The invention will be described using the example of a one gallon paint container. It is noted that although a one gallon paint container is being used to describe the invention, the invention can be applied to containers having different sizes and uses. In addition, the example shown in the drawings is a substantially square container having a round base. However, the invention can be applied to containers having different shapes.

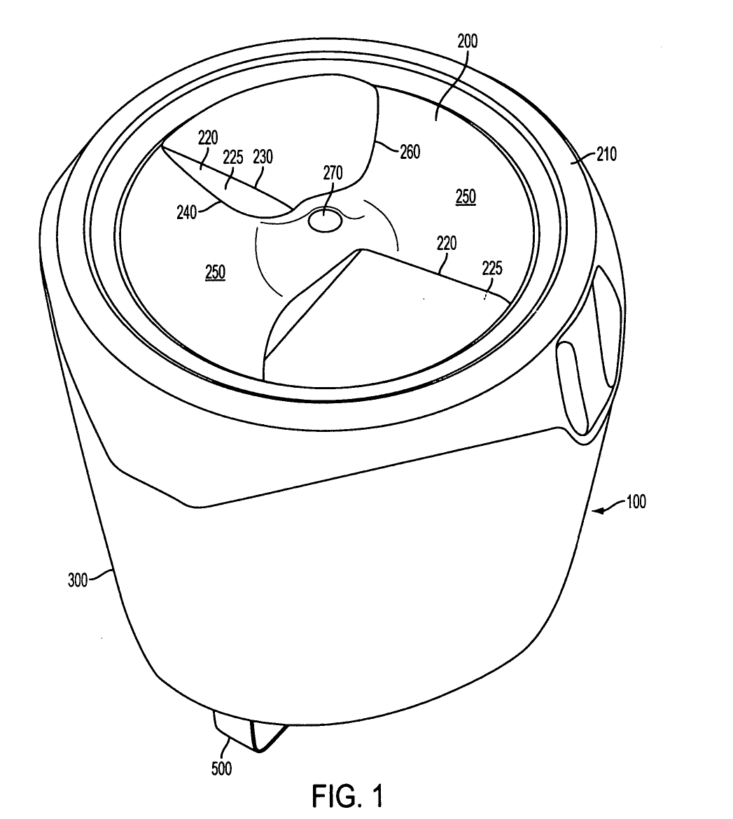

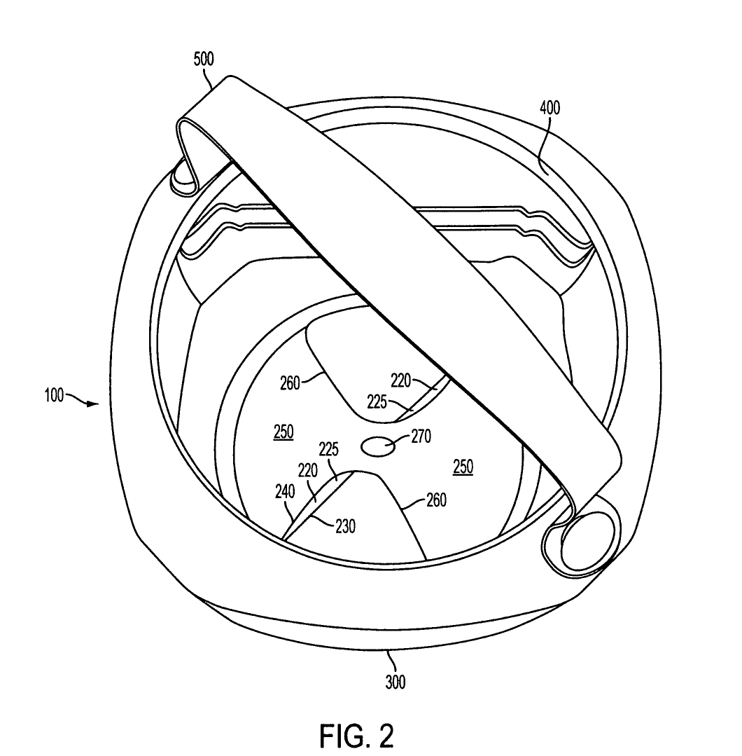

FIGS. 1 and 2 show a container 100 having a base 200 and a sidewall 300 connected to base 200. In this example, container 100 is a blow molded plastic container. However, containers in accordance with the invention can be made from other materials and by other methods.

Containers having a base in accordance with the invention enhance the mixing of viscous fluids within the container when the container is rotated or shaken. In the example shown in the drawings, the invention is applied to the base of a paint can that enhances the mixing of paint inside the can when the can is shaken with a shaking machine or when shaken by hand. By configuring the base of the container with one or more lobes or protrusions that protrude into the interior surface of the container, mixing is enhanced due to a wave effect caused within the fluid by the fluid being forced into contact with the protrusions. The protrusions are preferably shaped so that the container can be removed easily from a mold for making the container. Particular embodiments of the invention provide a shape with an extreme angle on one side and a lesser angle on the opposite side. This shape, when the container is rotated or reciprocated about a vertical central axis, will generate a wave effect within the fluid, thus causing enhanced mixing of the fluid. The wave or turbulence created by the container movement creates substantially more fluid motion within the container than a smooth bottom or base, resulting in more thorough and efficient mixing. The most motion is created near the bottom of the container, which is where heavy solids tend to settle in fluids. While the protrusions are shaped to promote mixing as discussed above, their shapes still allows the use of stirring sticks or paddles. This configuration is appropriate for at least quart, gallon and multi-gallon sizes as well as round, modified round, square and rectangular shaped containers.

Although two protrusions are shown in the figures, one, three or any number of protrusions can be used. Also, the shape of the protrusions can be other than the shapes shown as long as the protrusions promote mixing and demold easily. In particular embodiments, the face of the protrusion created by the more extreme angle relative to the base extends radially substantially the entire length from a central portion of the base to an outer periphery of the base.

In the example shown in the drawings, base 200 has two protrusions 220. Each protrusion 220 has a mixing surface 225 located between a lower edge 230 of the mixing surface and an upper edge 240 of the mixing surface. A sloping surface 250 extends from upper edge 240 and slopes down to an intersection 260 where sloping surface 250 intersects base 200. In this example, intersection 260 is a curved line.

In this example, base 200 has a support ring 210 that provides a flat surface on which the container rests when the container is placed on, for example, a table or floor. In particular embodiments, support ring 210 is shaped to interact with a top (not shown) of the container so that multiple containers can be securely stacked on top of each other.

In the example shown in the drawings, a handle 500 is provided to facilitate carrying container 100 and to facilitate rotational mixing by hand. Depending on the design and removability of handle 500, multiple containers can be stacked on top of each other as described above.

In the example shown in the figures, base 200 has a center 270 and protrusions 220 extend substantially the entire distance between center 270 and an outer limit of base 200. However, it is noted that protrusions 220 can be longer or shorter than the example shown in the figures.

The invention is not limited to the above-described exemplary embodiments. It will be apparent, based on this disclosure, to one of ordinary skill in the art that many changes and modifications can be made to the invention without departing from the spirit and scope thereof.

What is claimed is:

1. A plastic container for containing a fluid, the container comprising:
a base;
a sidewall attached to the base and extending upward from the base;
a top receiving portion for receiving a top for sealing the container; and at least one protrusion protruding upward from the base, the protrusion forming a mixing surface that is for promoting movement of the fluid when the container is shaken.

2. The container of claim 1, wherein the mixing surface has a lower edge, an angle between the mixing surface at its lower edge and the base being more than 90 degrees, and
the protrusion has a sloping surface that extends from an upper edge of the mixing surface and slopes down toward the base at an angle that is less than the angle between the mixing surface at its lower edge and the base.

3. The container of claim 2, wherein the sloping surface intersects the base along a curved line.

4. The container of claim 2, wherein the base further comprises a support ring for contacting a surface on which the container rests.

5. The container of claim 4, wherein the mixing surface extends more than half of the distance between a center of the base to the support ring.

6. The container of claim 5, wherein the mixing surface extends substantially completely from the center of the base to the support ring.

7. The container of claim 1, further comprising the top, the top having a support ring receiving portion for receiving the support ring of a second container.

8. The container of claim 1, wherein the mixing surface is for promoting formation of a wave within the fluid in order to facilitate agitation of the fluid.

9. The container of claim 1, wherein the mixing surface is for promoting formation of a wave within the fluid in order to facilitate mixing of particles within the fluid.

10. The container of claim 1, further comprising a second protrusion protruding upward from the base, the second protrusion forming a second mixing surface that is for promoting movement of the fluid when the container is shaken.

11. The container of claim 10, wherein the mixing surfaces each have a lower edge, an angle between the mixing surfaces at their lower edges and the base being more than 90 degrees, and
the protrusions each having a sloping surface that extends from an upper edge of the mixing surface and slopes down toward the base at an angle that is less than the angle between the mixing surfaces at its lower edges and the base.

12. The container of claim 11, wherein the sloping surfaces intersect the base along curved lines.

13. The container of claim 11, wherein the base further comprises a support ring for contacting a surface on which the container rests.

14. The container of claim 13, wherein the mixing surface extends more than half of the distance between a center of the base to the support ring.

15. The container of claim 14, wherein the mixing surfaces extend substantially completely from a center of the base to the support ring.

16. The container of claim 10, further comprising the top, the top having a support ring receiving portion for receiving the support ring of a second container.

17. The container of claim 10, wherein the mixing surfaces are for promoting formation of waves within the fluid in order to facilitate agitation of the fluid.

18. The container of claim 10, wherein the mixing surfaces are for promoting formation of waves within the fluid in order to facilitate mixing of particles within the fluid.
